(19) United States
(12) Patent Application Publication
(10) Pub. No.: US 2006/0173805 A1
(43) Pub. Date: Aug. 3, 2006

(54) Virtual file system

(75) Inventors: Brian Gerard Clifford, Scoresby (AU); Mark MacKowiak, Doncaster East (AU)

Correspondence Address: RYAN KROMHOLZ & MANION, S.C., POST OFFICE BOX 26618, MILWAUKEE, WI, 53226, US

(73) Assignee: Opticom Pty. Ltd.

(21) Appl. No.: 11/049,414

(22) Filed: Feb. 2, 2005

(30) Foreign Application Priority Data
Jan. 28, 2005 (AU) 2005200362

(51) Int. Cl. G06F 17/30

(52) U.S. Cl. 707/1

(57) ABSTRACT

There is disclosed a method for managing information about off-line storage data comprising storing information about the off-line storage data, interfacing said information with a file manager of an operating system of a computer, displaying said off-line storage data as accessible by said computer as part of the file system managed by said file manager so that the information stored about the off line storage data can be accessed by using the file manager.

### FIELD OF THE INVENTION

The present invention relates to a virtual file system.

### BACKGROUND OF THE INVENTION

Content stored on optical media such as a DVD, Audio CD, or CD ROM disc and the like are commonly used with computers. Typically, these optical media are stored in a storage rack or box and the computer includes an optical reader into which an optical media is inserted.

Generally, in order to run a program that has been loaded onto a computer but in order to run requires components stored in a CD ROM, the operator will click on an icon on the screen on the computer in order to initiate running of the program. However, the operator must also locate the relevant CD ROM and insert the specific CD ROM into the CD ROM reader of the computer. The computer can then read from and/or write onto the CD ROM and run the program in accordance with the software contained on the CD ROM, or interact with data or software contained on the CD ROM under the control of software or data included in the PC. Accordingly, it is important that the operator be able to readily locate such programs. Searching for specific data files stored on CD ROM is another problem. If an operator has backed up data to off-line optical media and then later wants to find that data, the operator must either know what disc the relevant file is on and then insert that disc or try many discs until the operator locates the right one.

The handling of CD ROMs, particularly if an operator has a large quantity of CD ROMs, can therefore be time consuming and bothersome. Therefore a need exists for a technique for presenting the information about off-line content such as that contained in storage medium such as optical discs.

### BRIEF DESCRIPTION OF THE INVENTION

The invention provides a method for managing information about off-line storage data comprising:

storing information about the off-line storage data;

interfacing said information with a file manager of an operating system of a computer,

displaying said off-line storage data as accessible by said computer as part of the file system managed by said file manager so that the information stored about the off-line storage data can be accessed by using the file manager.

The invention also provides a computer for managing information about off line storage data comprising:

an operating system; and

a virtual file system application interfaced with a file manager of said operating system, the virtual file system application storing information about off-line storage data, and displaying said off-line storage data as part of the file system managed by the file manager, whereby said information can be accessed using the file system.

The invention also provides a computer program that when executed by a computer:

stores information about the off-line storage data;

interfaces said information with a file manager of an operating system of a computer, and

displays said off-line storage data as accessible by said computer as part of the file system managed by said file manager so that the information stored about the off-line storage data can be accessed by using the file manager.

Preferably, said computer program is stored on a program storage device readable by said computer.

The invention also provides a set of application program interfaces embodied on a computer-readable medium for execution on a computer in conjunction with an application program that manages information about one off-line storage data physically stored in one or more storage units comprising:

a unit interface that interfaces between a file management system of an operating system of a computer and the one or more storage units;

a disc interface that interfaces between said file management system and said one or more storage media;

a storage data interface that interfaces between said file management system and a database containing information related to said storage data;

a view handler interface that displays said storage data or more storage media including said information as accessible to said computer as part of said file management system.

The invention also provides in a computer system having a graphical user interface including a display and a selection device, a method for managing off-line storage data, the method comprising:

retrieving information from a database including data related to the off-line storage data; and

displaying said information related to said off line storage data as part of the file system managed by a file manager.

The invention also provides a method for displaying data about off-line storage data comprising:

storing information related to the off-line storage data; and

displaying information related to the off-line data with a file manager of an operating system of a computer.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram schematically illustrating a system for managing one or more off-line storage media in accordance with one embodiment of the present invention;

FIG. 2 is a diagram schematically illustrating the software architecture in accordance with one embodiment of the present invention;

FIG. 3 is a screenshot displaying the storage units in accordance with one embodiment of the present invention;

FIG. 4 is a screenshot displaying a list of optical media physically stored in a selected storage unit in accordance with one embodiment of the present invention;

FIG. 5 is a screenshot displaying the content of a selected optical media of a storage unit in accordance with one embodiment of the present invention;

FIG. 6 is a flow diagram schematically illustrating a method for managing one or more off-line storage media in accordance with one embodiment of the present invention; and

FIG. 7 is a flow diagram schematically illustrating a method for managing one or more off-line storage media in accordance with another embodiment of the present invention.

### DETAILED DESCRIPTION

Embodiments of the present invention are described herein in the context of a virtual file system. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

In accordance with one embodiment of the present invention, the method may be implemented on a data processing computer such as a personal computer, workstation computer, mainframe computer, or high performance server running an OS such as Mac OSX available from Apple of Cupertino, Microsoft® Windows® XP and Windows® 2000, Windows ME, Windows 98 SE, all available from Microsoft Corporation of Redmond, Wash., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet.

In accordance with one embodiment of the present invention, data about the content of an off-line storage medium (for example, CD or DVDs) interfaces with the file management system of a computer (for example, Windows Explorer) to present and display the data as being from a physical device physically coupled to the computer (for example, a disc drive or memory card reader) although the storage medium may not be physically coupled to the computer. For example, a user could browse the content of an off-line CD in Windows Explorer with the appearance of the off-line CD being in another device physically connected to the computer.

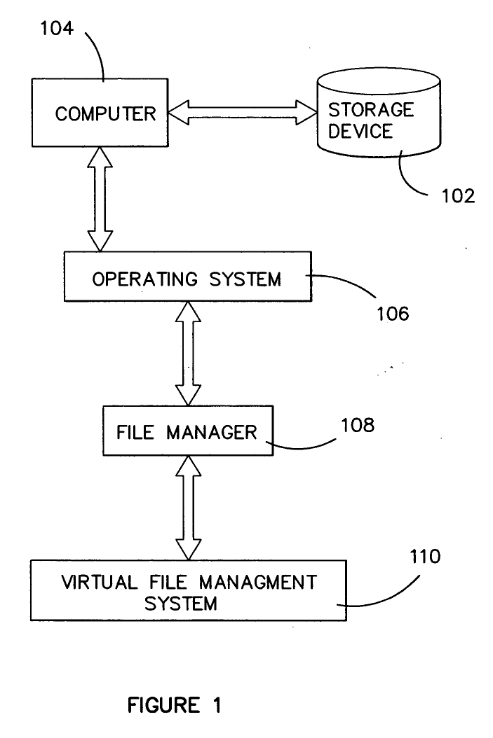

In accordance with one embodiment of the present invention, FIG. 1 illustrates a system 100 for managing information from one or more off-line storage medium physically stored in one or more storage unit/device. A storage device 102 communicates with a computer 104, for example, using a Universal Serial Bus (USB) connector (not shown). The storage device 102 provides an organized physical storage space for media such as optical media. For example, the storage device 102 may include a rotating carousel capable of storing up to 100 optical media such as Audio CDs, CD-ROM, DVDs, etc. . . .

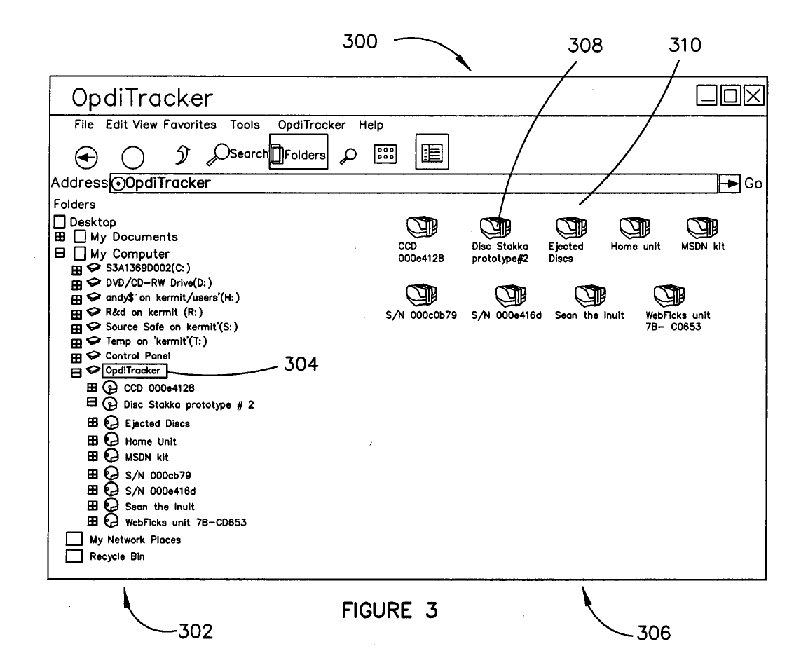

The computer 104 includes an operating system (OS) 106. Those of ordinary skills in the art will recognize that many other OS such as Windows® OS or Mac OS may be loaded in the computer 104. The OS 106 may also include a file management application 108 such as Windows Explorer in Microsoft Windows®. The file management application 108 organizes content residing on any storage device that is currently accessible by the computer 104—i.e. the file can be retrieved and used by the computer 104 if it is instructed to do so. For example, the file management application 108 may list the content of a hard drive, a floppy drive, a CD drive, an attached removable memory drive, etc. . . . In the case of Windows Explorer the listed content is organized in the form of a tree with branches as further illustrated in FIGS. 3-5. Herein “content” includes files (executable or otherwise), folders, optical media, magnetic media and the like.

A virtual file system application 110 interfaces with the file management application 108. The virtual file system application 110 provides means for presenting information about any off-line storage data. Herein “off-line” means that the storage data is not currently physically accessible by the computer. Herein the term “storage data” is used to refer to content of storage media stored on media and/or the media itself. The virtual file system is described in relation to media storage devices that store discs (e.g. 100 discs) but do not have a CD/DVD drive to read the discs or, for example, store a large number of discs (e.g. 100) but can only read one at a time. Therefore, the information about the optical discs may not be discovered or explored alone using the storage device 102 even though data about the nature of the discs and where they are stored is maintained by the virtual file system. Thus, the virtual file system application 110 provides a comprehensive database and search engine for the efficient management of optical media and their content including CDs, DVDs, music, or games discs stored in storage device 102. Persons skilled in the art will appreciate that the virtual file system can be used to manage files/data stored on any storage media and all media types.

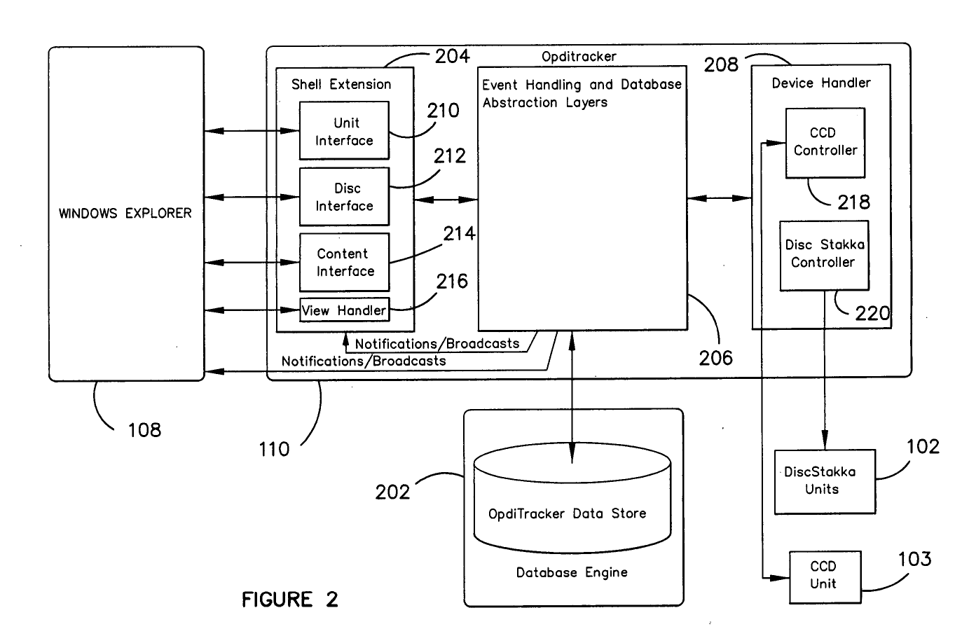

The virtual file system application 110 interfaces with the Windows Explorer or Mac Finder environment of a file management application 108 and gives the appearance of the storage device 102 as being another physical device connected to the computer 104, such as for example, a hard drive (C:) or CD-ROM drive. The virtual file system application 110 allows the user to expand a tree view and move to a depth required (system, unit, disc, folder, sub folder, file, etc . . . ) and to be able to search on any of these levels. The software architecture of the virtual file system application 110 is described below in more detail in FIG. 2.

FIG. 2 is a diagram schematically illustrating the software architecture of a virtual file system in accordance with one embodiment of the present invention. The virtual file system application 110 interfaces with the file management application 108, one or more optical media storage unit 102 of a first type, one or more media storage unit 103 of a second type, and a database engine 202.

The database engine 202 stores data about each optical storage unit 102, the optical media and the content of each optical media (i.e. CD, DVD, etc . . . ) stored in the optical media storage unit 102. For example, the information stored in the database engine 202 may include, but is not limited to: an identification or “name” of each optical media storage unit, the unit's activity state (e.g. connected, disconnected, error state, history of operations; usage, number of full and empty slots; miscellaneous user comments); the name of each optical media in each optical media storage device, the type of optical media (for example, DVD, audio CD, CD-ROM, etc . . . ), the volume label (either as read from disc or entered by the user); type of disc as read from disc or entered by the user; an image that may be associated with the disc, user comments, usage details, type, and date of creation, last modification, size of each files stored on each optical media. This information may be either entered manually by a user, or captured by an optical drive (for example, CD or DVD drive) reading the optical media. Those of ordinary skills will recognize that there exists many other ways of capturing the content information of an optical media.

The structure of the virtual file system application 110 includes a shell extension module 204, an event handling and database abstraction layer module 206, and a device handler 208. The shell extension module 204 interfaces between the file management application 108 and the event handling and database abstraction layer module 206. The event handling and database abstraction layer module 206 interfaces between the shell extension module 204, the device handler module 208, and the database engine 202. The device handler module 208 includes a controller 218 and controller 220 each respectively controlling the storage units of the second 103 and first 102 types. The structure is such that as many controllers as device types can be added. The device handler module 208 interfaces between the event handling and database abstraction layers 206 and second unit type 103 and first unit type 102. It should be noted that the virtual file system application 110 does not need the optical media storage units 102 or 103 to be physically coupled with the computer 104. Indeed, the virtual file system can be provided without any units at all, for example, by providing an interface for direct entry of data into database engine 202. However, interfacing with the units 102,103 allows information to be stored about where the optical media are located within units 102,103 and hence, allows some control of the units 102,103.

The shell extension module 204 includes a unit interface module 210, a disc interface module 212, a content interface module 214, and a view handler 216.

The unit interface module 210 identifies each optical media storage device 102 as a unit drive even when the optical media storage devices 102 are off-line. A virtual folder called an “Ejected Discs” folder is also controlled by the unit interface module 210 for the purpose of identifying a list of discs that are not currently stored within an optical media storage devices 102. The unit interface module 210 interfaces with the file management application 108 to integrate and present the data from each unit as part of the file management application 108. Data is retrieved from the database engine 202 using the interface to the event handling and database abstraction layer module 206. Data may include, but is not limited to, the name of each unit, its state and operational mode. The virtual file system application 110 allows the user to control one or more optical media storage devices 102,103 through the unit interface module 210.

The disc interface module 212 identifies all the discs stored in an optical media storage device 102 even when the optical media storage devices 102 are off-line and all known discs that are not currently stored in units held in the database engine 202. The disc interface module 212 interfaces with the file management application 108 to integrate and present the data from the discs stored in the optical media storage device 102 and held in the “Ejected Discs” folder as part of the file management application 108. Data is retrieved from the database engine 202 using the interface to the event handling and database abstraction layer module 206. Data may include, but is not limited to, the name of each disc, its state, and disc type (for example, DVD, audio CD, CD-ROM, etc . . . ). The virtual file system application 110 allows the user to control one or more discs through the disc interface module 212. It will be appreciated that this technique can be applied to all types of storage media and units for storing media and can be used to handle any number of units.

The content interface module 214 identifies the content of each disc stored in an optical media storage device 102 even when the optical media storage devices 102 are off line and all ejected discs held in the database engine 202. The content interface module 214 interfaces with the file management application 108 to integrate and present the data from a selected disc stored in the optical media storage device 102 as part of the file management application 108. Data is retrieved from the database engine 202 using the interface to the event handling and database abstraction layer module 206. Data may include, but is not limited to, the name of each file (or folder), its size, and type. The virtual file system application 110 allows the user to search files and folders to find information about storage units, optical media and the content of the media.

The view handler module 216 provides means for displaying a selected view of the request information on the content of each unit, disc, or folder, including the “Ejected Discs” folder. The view manager allows display of information at several levels:

at system level—units and ejected disc folder information is displayed in the selected view;

at unit level—disc information is displayed in the selected view;

at disc level—content information is displayed in the selected view; and

at content level—sub folder & file information is displayed in the selected view. This is further illustrated by screenshots in FIGS. 3-5. The view handler module 216 interfaces with the file management application. User interaction can occur with the view handler module 216, thereby appropriate information is presented to the file management application 108 by retrieving and formatting the required data from the database engine 202 using the interface to the event handling and database abstraction layers 206.

The shell extension module 204 interacts with the file management application 108 to present unit, disc and content information and handle the views. For the file management application 108 such as Windows Explorer in Microsoft Windows®, this interaction and presentation is performed via Component Object Model (COM) and shell interfaces, COM objects and Shell Application Programming Interfaces (APIs). A number of interfaces are exposed by the shell extension module 204 such as IContextMenu (to set information relating to popup menus), IEnumIDList (to enumerate information relating to units, discs and contents), IExtractIcon (to return icon information for each data object), IShellFolder (to setup a folder hierarchy, object information, object attributes, object ordering, etc . . . ), IShellPropSheetExt (to display property pages) and IShellView (to present information about the contents of objects). Persons skilled in the art will appreciate that the application does not utilise several additional available interfaces. Similarly an implementation could be done using not all the listed interfaces. Each interface provides specific functionality so not implementing an interface or providing additional interfaces will result in different functionality of the application.

The event handling and database abstraction layer module 206 is an intermediary layer between the shell extension module 204 and the device handler 208 while utilizing the database engine 202 to store unit, disc and content information. User interaction from the shell extension module 204 causes the event handling and database abstraction layer module 206 to add, update and delete records from the database engine 202 and to control the optical media storage device 102,103 via the device handler 208. Activity states returned by the device handler 208 from the optical media storage device 102 are maintained by the event handling and database abstraction layer module 206 and ultimately stored in the database engine 202. Notifications of changes to units, discs and contents are sent from the event handling and database abstraction layer 206 to the shell extension module 204 and the file management application 108. Notifications sent to the shell extension module 204 are in the form of system broadcasts (the PostMessage API on Microsoft Windows® with the HWND_BRODCAST parameter) and allow the view handler module 216 to update the current view by retrieving the latest data from the database engine 202 via the event handling and database abstraction layers module 206. Data changes may be due to an optical media storage device unit changing state (becoming active or inactive, ejecting a disc, disc inserted etc.), a user updating a database record (changing the device name, disc type, etc.), etc. . . . Notifications that are sent to the file management application 108 are Shell events (the SHChangeNotify API on Microsoft Windows®) and update the tree control with the latest data from the database engine 202 via the event handling and database abstraction layers module 206. As discs are ejected and stored into the optical media storage device 102 as a result of user interaction, the event handling and database abstraction layer 206 retrieves information from the device handler module 208 and updates the record in the database engine 202 to enable the disc to be put into or taken out of the “Ejected Discs” folder.

The device handler 208 has the ability to control different types of optical media storage devices 102,103. Moreover, the device handler 208 is capable of communicating with multiple optical media storage device units of a particular type, whether they are connected via separate USB connections or stacked to the maximum allowed by the optical media storage device 102. Each type of optical media storage device 102,103 is controlled by its associated module within the device handler 208. Each module is responsible for coordinating communication with all optical media storage devices of that particular type. Data packets are retrieved from the optical media storage device units 102,103 and processed by the associated module within the device handler 208. Processing takes into account, but is not limited to, the position of the unit's carousel, its operational state, issuing of commands and responses, etc. The device handler 208 passes this information to the event handling and database abstraction layers module 206 where it is stored in the database engine 202 (i.e. that database engine includes the data store) and relevant notifications/broadcasts are sent to the shell extension 204 and file management application 108 for presentation and visual feedback.

FIG. 3 is a screenshot 300 displaying the storage units with an icon view in accordance with one embodiment of the present invention. The left panel 302 displays a tree listing drives and devices communicating with the computer (C: drive, D: DVD drive, etc . . . ). The virtual file system application is displayed as a system folder 304 (OpdiTracker). The branch view under the OpdiTracker drive 304 is expanded to display a list of optical media storage device units (CCD 00034128, Disc Stakka prototype #2, etc. . . . ). The right panel 306 of the screenshot 300 displays a series of icons, each representing an optical media storage device unit 308 or an ejected disc folder 310. The ejected disc folder 310 is a folder storing a list of discs that are not currently stored within the storage device units 308.

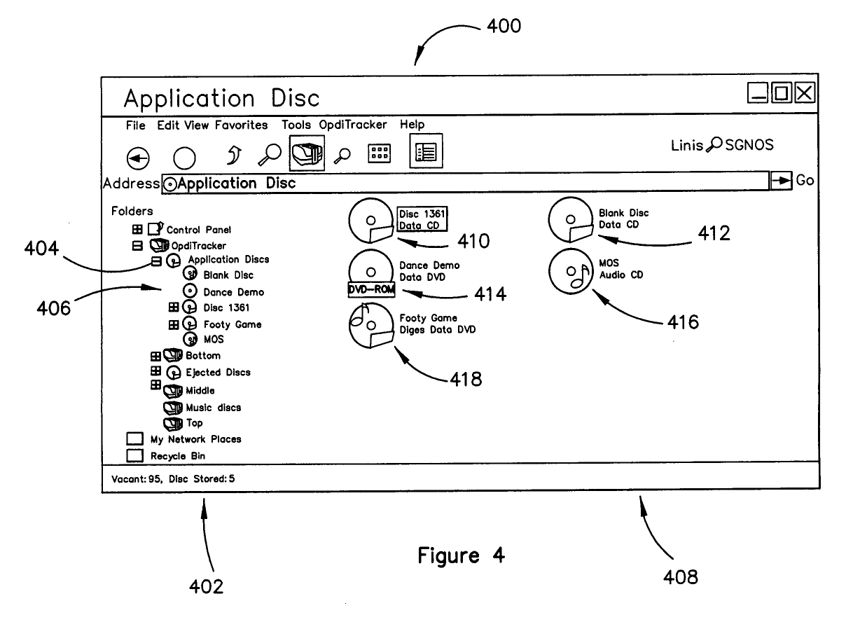

FIG. 4 is a screenshot 400 displaying a list of optical media stored in a selected storage unit in accordance with one embodiment of the present invention. The left panel 402 displays a tree under which a selected optical media storage device unit 404 has an exploded view 406. The exploded view 406 lists the name of each optical media stored in the selected optical media storage device unit 404. The right panel 408 displays a series of icons, each representing an optical media stored in the selected optical media storage device unit 404: data discs 410, 412, 418, DVD disc 414, and Audio CD 416.

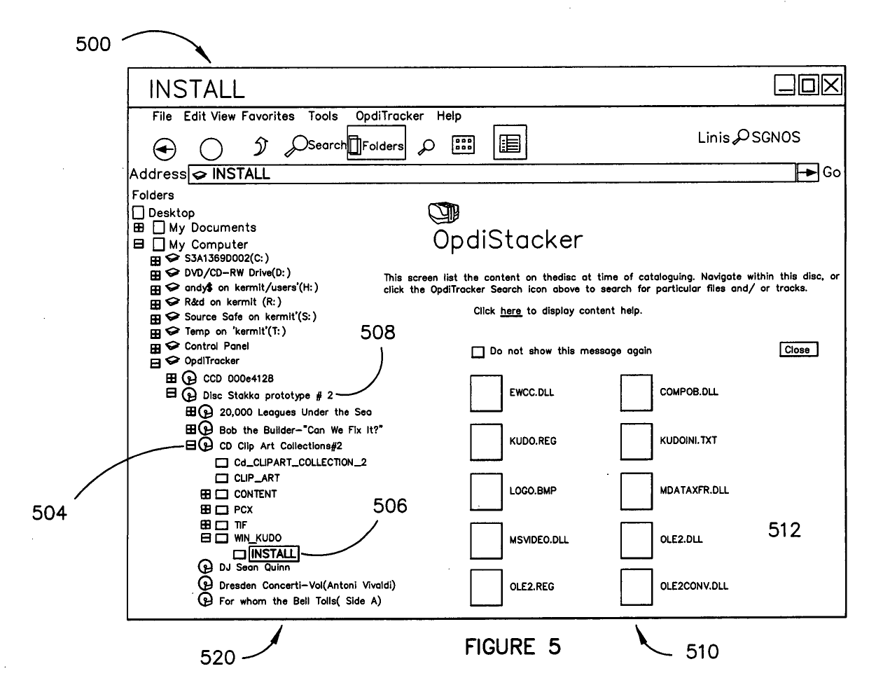

FIG. 5 is a screenshot 500 displaying the content of one selected optical media of a storage unit in accordance with one embodiment of the present invention. The left panel 502 displays a tree under which a selected optical media 504 has an exploded view. The exploded view lists the content of a selected file folder 506 of the selected optical media 504 from the selected optical media storage device unit 508. The right panel 510 displays a series of icons 512, each representing a file from the selected folder 506 of the selected optical media 504.

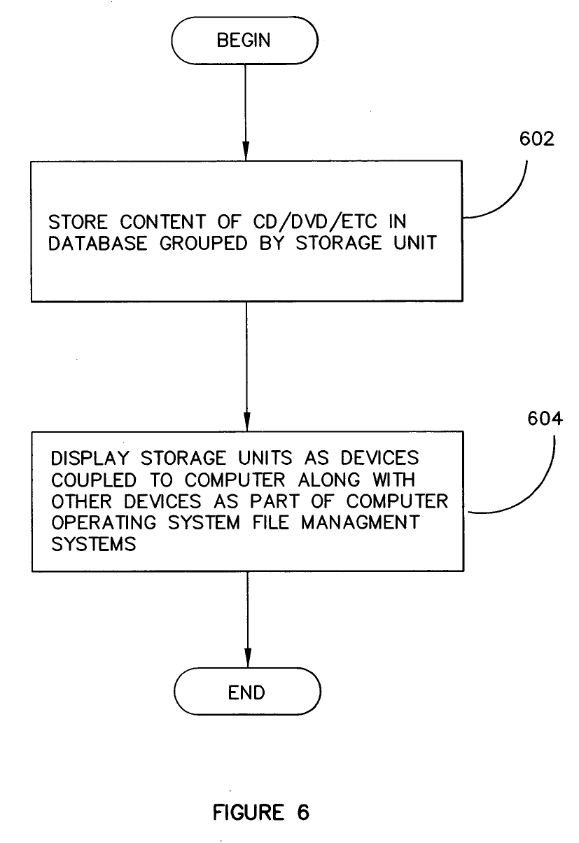

FIG. 6 is a flow diagram schematically illustrating a method for managing the content one or more off-line optical media (CD, DVD, etc . . . ) in accordance with one embodiment of the present invention. At 602, the content of one or more optical media is stored in a database communicating with a computer and grouped by storage unit. Each storage unit physically storing one or more optical media. At 604, the storage units as devices coupled to the computer along with other devices as part of the computer's operating System's management file application (i.e. Windows Explorer in Windows). Within each storage unit information is presented about the media, within each media information about the contents is presented. The information stored in the database on each off-line optical media may be captured with an optical reader such as a CD or DVD drive connected to the computer or entered manually by an operator.

The virtual file system application 110 allows the storage units to be displayed as devices even though the storage units does not read or write onto the physically stored optical media. The virtual file system includes the following modules: database engine 202, shell extension 204, event handling and data base extraction 206, the device handler 208 is also required if devices are to be used.

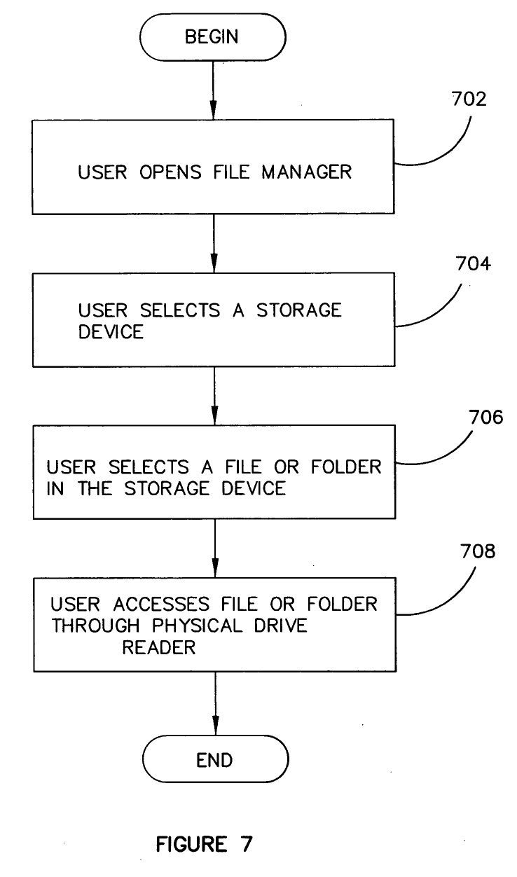

FIG. 7 is a flow diagram schematically illustrating a method for managing at least one off-line optical media in accordance with another embodiment of the present invention. At 702, a user opens a file manager application of an operating system (for example, Windows Explorer, or Apple Macintosh OS Finder). The file manager lists the drives and devices connected to the computer. The optical media storage device is listed as a device in the file manager application. The user may move to whatever depth in the file folder tree. The content at the selected level is displayed in the view pane of the window of the file manager. At 704, the user selects an optical media storage device to display the unit/disc/file information presented in a view pane in the file manager window. At 706, the user may select any file or folder from a tree as desired. If the user wishes to access a particular file, the disc containing that particular file may be automatically selected and ejected from the connected optical media storage device unit. If that particular selected disc is not available, the user may be notified. At 708, the user accesses files by inserting the selected/ejected disc through an optical reader (for example, a CD drive) physically connected to the computer.

Thus, a feature provided by the preferred embodiment of the present invention is that a user does not need a special program to browse off-line storage data and can access data about the off-line storage data using the file manager in the same way they would access content accessible by the computer.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

The claims defining the invention are as follows:

1. A method for managing information about off-line storage data comprising:
storing information about the off-line storage data;
interfacing said information with a file manager of an operating system of a computer,
displaying said off-line storage data as accessible by said computer as part of the file system managed by said file manager so that the information stored about the off-line storage data can be accessed by using the file manager.

2. A method as claimed in claim 1 further comprising:
interfacing said information with said file manager with a virtual file system application.

3. A method as claimed in claim 1 further comprising editing or adding to said information in response to a user request.

4. A method as claimed in claim 2 further comprising capturing said information with a content reader communicatively coupled to said computer.

5. A method as claimed in claim 2 further comprising storing said information in a database engine.

6. A method as claimed in claim 1 further comprising storing at least some of said off-line storage data in a media storage unit that cannot retrieve said off-line storage data.

7. A method as claimed in claim 6 wherein said media storage unit is configured to house one or more optical media.

8. A method as claimed in claim 2 wherein said virtual file application comprises:
a shell extension module communicatively coupled to said operating system,
an event handling and database abstraction layer module communicatively coupled to said shell extension, and
a database engine communicatively coupled to said event handling and database abstraction layer module.

9. A method as claimed in claim 8 further comprising a device handler.

10. A method as claimed in claim 9 wherein said device handler is communicatively coupled with one or more storage units.

11. A method as claimed in claim 8 wherein said shell extension includes a unit interface, a disk interface, a content interface, and a view handler.

12. A method as claimed in claim 1 wherein said file manager provides a graphical user interface.

13. A computer for managing information about off line storage data comprising:
an operating system; and
a virtual file system application interfaced with a file manager of said operating system, the virtual file system application storing information about off-line storage data, and displaying said off-line storage data as part of the file system managed by the file manager, whereby said information can be accessed using the file system.

14. A computer as claimed in claim 13 wherein said virtual file system application includes:
a shell extension module communicatively coupled to said operating system,
an event handling and database abstraction layer module communicatively coupled to said shell extension, and
a database engine communicatively coupled to said event handling and database abstraction layer module.

15. A computer as claimed in claim 14 further comprising a device handler communicatively coupled to said event handling and database abstraction layer module.

16. A computer as claimed in claim 14 wherein said shell extension includes a unit interface, a disk interface, a content interface, and a view handler.

17. A computer as claimed in claim 13 wherein one or more storage units for storing off-line storage data is communicatively coupled to said device handler.

18. A computer program that when executed by a computer:
stores information about the off-line storage data;
interfaces said information with a file manager of an operating system of a computer, and
displays said off-line storage data as accessible by said computer as part of the file system managed by said file manager so that the information stored about the off-line storage data can be accessed by using the file manager.

19. A program storage device readable by a computer storing the computer program of claim 18.

20. A computer program as claimed in claim 18 wherein said computer program:
interfaces said information with said file manager.

21. A computer program as claimed in claim 18 wherein said computer program edits or adds to said information in response to a user request.

22. A computer program as claimed in claim 20 wherein said computer program captures said information with a content reader communicatively coupled to a computer.

23. A computer program as claimed in claim 20 wherein said computer program stores said information in a database engine.

24. A computer program as claimed in claim 18 further comprising storing at least some of said off-line storage data in a media storage unit that cannot retrieve said off-line content.

25. A computer program as claimed in claim 20 wherein said computer program comprises:
a shell extension module communicatively coupled to said operating system,
an event handling and database abstraction layer module communicatively coupled to said shell extension, and
a database engine communicatively coupled to said event handling and database abstraction layer module.

26. A computer program as claimed in claim 25 wherein said event handling and database abstraction layer module is communicatively coupled with a database engine.

27. A computer program as claimed in claim 25 wherein said device handler is communicatively coupled with one or more storage units.

28. A computer program as claimed in claim 25 wherein said shell extension includes a unit interface, a disk interface, a content interface, and a view handler.

29. A computer program as claimed in claim 18 wherein said file manager provides a graphical user interface.

30. A set of application program interfaces embodied on a computer-readable medium for execution on a computer in conjunction with an application program that manages information about one off-line storage data physically stored in one or more storage units comprising:
a unit interface that interfaces between a file management system of an operating system of a computer and the one or more storage units;
a disc interface that interfaces between said file management system and said one or more storage media;
a storage data interface that interfaces between said file management system and a database containing information related to said storage data;
a view handler interface that displays said storage data or more storage media including said information as accessible to said computer as part of said file management system.

31. In a computer system having a graphical user interface including a display and a selection device, a method for managing off-line storage data, the method comprising:
retrieving information from a database including data related to the off-line storage data; and
displaying said information related to said off line storage data as part of the file system managed by a file manager.

32. A method for displaying data about off-line storage data comprising:
storing information related to the off-line storage data; and
displaying information related to the off-line data with a file manager of an operating system of a computer.
